(19) United States
(12) Patent Application Publication
(10) Pub. No.: US 2017/0023536 A1
(43) Pub. Date: Jan. 26, 2017

(54) Modular Multiple-Column Chromatography Cartridge

(71) Applicant: Thermo Finnigan LLC, San Jose, CA (US)

(72) Inventor: John E. BRANN, Shrewsbury, MA (US)

(73) Assignee: Thermo Finnigan LLC

(21) Appl. No.: 15/284,411

(22) Filed: Oct. 3, 2016

Related U.S. Application Data
(62) Division of application No. 13/882,116, filed on May 2, 2013, now abandoned.
(60) Provisional application No. 61/408,044, filed on Oct. 29, 2010.

(51) Int. Cl. G01N 30/60; B01L 3/00; G01N 30/46; G01N 30/88; B01D 15/22; G01N 30/30

(52) U.S. Cl. CPC G01N 30/6043; B01D 15/22; G01N 30/30; G01N 30/466; G01N 30/6091; G01N 30/88; B01L 3/545; G01N 2030/387

(57) ABSTRACT

A method for liquid chromatography comprises steps of: mixing a sample comprising a plurality of chemical constituents with a first solvent; transferring the solvent and the plurality of constituents to a first chromatographic column housed in a cartridge; chromatographically separating a sub-group of the plurality of constituents from unwanted constituents using the first chromatographic column; transferring the sub-group of the plurality of constituents from the first chromatographic column to a second column housed in the cartridge, the transferring effected by the flow of a second solvent; chromatographically separating, from one another, individual constituents of the sub-group of the plurality of constituents using the second chromatographic column; and transferring the separated individual constituents to a detector.

### CROSS-REFERENCE TO RELATED APPLICATIONS

This application is a Divisional application of U.S. patent application Ser. No. 13/882,116, having a 371(c) date of May 2, 2013, which is the United States National Stage application, under 35 U.S.C. 371, of International Application PCT/US2011/058229 having an international filing date of Oct. 28, 2011, which claims the benefit of the filing date, under 35 U.S.C. 119(e), of U.S. Provisional Application 61/408,044, filed on Oct. 29, 2010, the entire disclosures of all of which are incorporated by reference.

### TECHNICAL FIELD

This invention generally relates to chromatography, and more particularly to a cartridge module for simultaneously fluidically coupling at least two chromatography columns to fluid-carrying tubing within a liquid chromatography system.

### BACKGROUND ART

Liquid chromatography (LC) is well-known in the fields of chemical separation, compound purification and chemical analysis. A central component of a liquid chromatography system is a chromatographic column. The column comprises a capillary tube that is packed with a permeable solid material that either is, itself, a chromatographic stationary phase or otherwise comprises or supports a chromatographic stationary phase. A fluid mixture comprising both a compound of interest for purification or separation as well as a chromatographic mobile phase is caused to flow through the column under pressure from an input end to an output end. Generally, the chemical properties of the stationary phase and the mobile phase are such that the degree of partitioning of the compound of interest between the mobile phase and the stationary phase is different from the degree of partitioning of other compounds within the fluid. As a result, the degree of retention or time of retention of the compound of interest within the column is different from the degree or time of retention of the other compounds, thus causing a physical separation or partial purification of the compound of interest from the other compounds.

As used herein, “liquid chromatography” (LC) means a process of selective retention of one or more components of a fluid solution as the fluid uniformly percolates through a column of a finely divided substance, or through capillary passageways. The retention results from the distribution of the components of the mixture between one or more stationary phases and the bulk fluid, (i.e., mobile phase), as this fluid moves relative to the stationary phase(s). “Liquid chromatography” includes, without limitation, reverse phase liquid chromatography (RPLC), high performance liquid chromatography (HPLC), ultra high performance liquid chromatography (UHPLC), supercritical fluid chromatography (SFC) and ion chromatography.

As used herein, the term “HPLC” or “high performance liquid chromatography” refers to liquid chromatography in which the degree of separation is increased by forcing the mobile phase under pressure through a stationary phase, typically a densely packed column.

As used herein, the term “UHPLC” or “ultra high performance liquid chromatography” refers to a liquid chromatography technique similar to HPLC except the operating pressures are higher than HPLC (e.g., about 100 MPa vs. about 40 MPa), the columns are typically smaller in diameter, and resolution can be greater.

Chromatography may be used to purify or enrich one or more analytes of a sample, prior to analysis by mass spectrometry. The chromatography step or steps are generally used to enrich one or more analytes of interest relative to one or more other components of the sample. Typically, one or more methods including, without limitation, liquid chromatography, HPLC, UHPLC, precipitation, dialysis, affinity capture, electrophoresis, or other suitable methods known in the art, are used for the purification.

Various methods have been described involving the use of HPLC for sample cleanup prior to mass spectrometry analysis. For example, see, e.g., Taylor et al., Therapeutic Drug Monitoring 22:608-12 (2000) (manual precipitation of blood samples, followed by manual C18 solid phase extraction, injection into an HPLC for chromatography on a C18 analytical column, and MS/MS analysis); and Salm et al., Clin. Therapeutics 22 Supl. B:B71-B85 (2000) (manual precipitation of blood samples, followed by manual C18 solid phase extraction, injection into an HPLC for chromatography on a C18 analytical column, and MS/MS analysis). One of skill in the art can select HPLC instruments and columns that are suitable for use in the invention. The chromatographic column typically includes a medium (i.e., a packing material) to facilitate separation of chemical moieties (i.e., fractionation). The medium may include minute particles. The particles may include a bonded surface that interacts with the various chemical moieties to facilitate separation of the chemical moieties. One suitable bonded surface is a hydrophobic bonded surface such as an alkyl bonded surface. Alkyl bonded surfaces may include C-4, C-8, or C-18 bonded alkyl groups, preferably C-18 bonded groups. The chromatographic column includes an inlet port for receiving a sample and an outlet port for discharging an effluent that includes the fractionated sample. For example, a test sample may be applied to the column at the inlet port, eluted with a solvent or solvent mixture, and discharged at the outlet port.

In another example, more than one column may be used wherein a test sample may applied to a first column (e.g., a cleanup column) at the inlet port, eluted with a solvent or solvent mixture onto a second column (e.g., an analytical column), and eluted with a solvent or solvent mixture from the second column to the outlet port. Different solvent modes may be selected for eluting the analytes. For example, liquid chromatography may be performed using a gradient mode, an isocratic mode, or a polytypic (i.e. mixed) mode.

Complex samples, such as biologically-derived fluids, may contain a large number of compounds. Generally, a laboratory analysis will be directed to detect the presence (vs. absence) or the concentrations of a limited number of target compounds within the complex sample. Frequently, a chromatographic signature (or signatures) of the target compound (or compounds) will be masked by the elution properties of much-more-abundant matrix compounds. Therefore, it is often desirable to perform two-stage or multiple-stage chromatographic separations in order to increase analyte signal strength or to improve the ability to discriminate the analyte signal from background noise or other interferences. A first such step—i.e., a “cleanup” step—may be employed to separate certain classes or sub-sets of compounds from one another (e.g. large molecule versus small molecule, or polar versus non polar) with the fraction that may contain possible analyte substances retained and the other fraction discarded. Then, in a second chromatographic separation step—i.e., an “analytical” step—the retained fraction may be separated into particular isolated compounds. Such two-stage or multiple-stage separations may require multiple chromatographic columns, each such column uniquely optimized to perform a particular type of separation.

FIG. 1 is a schematic illustration of an example of a conventional liquid chromatography system having two chromatography columns. The system 10 shown in FIG. 1 comprises a first chromatography column 7a (a “cleanup” column) for conducting an initial separation of a liquid chemical mixture so as to isolate a sub-group of its constituent substances as well as a second chromatography column 7b (an “analytical” column) for performing a more finely resolved or finely detailed separation of the constituents of the isolated sub-group. The system also comprises a detector 31 fluidically coupled to the second column 7b for detecting or identifying the separated constituent substances as they are received, in sequence from the second column 7b. Frequently, the detector 31 comprises a mass spectrometer but may also be any other suitable form of chemical detector, such as an infrared or fluorescence spectrograph.

In operation of the system 10 (FIG. 1), the first column 7a receives a fluid stream comprising one or more selected solvent fluids supplied from solvent containers 8 and also receives a fluid, from sample source 4, comprising one or more samples of interest and possibly also a solvent. The various different solvent fluids may comprise a chromatographic mobile phase. The solvent fluids from containers 8 are delivered along fluid tubing lines 6a to valve or mixing apparatus 9 which may mix the fluids or may select a particular fluid. The solvent fluids are drawn into the system 10 and propelled to downstream components thereof by means of a first pump 11a (e.g., an eluting pump) that is fluidically coupled to the output of the valve 9 by fluid tubing line 6b. The solvent fluids output from the pump along fluid tubing line 6c are delivered to an input of a valve system 5. In similar fashion, the sample fluid or fluids from sample source 4, together with any admixed solvents, are delivered into the system 10 through fluid tubing line 6d under the action of a second pump 11b (e.g., a loading pump). The sample fluid or fluids together with any admixed solvents, enter another input of the valve system 5 by means of fluid tubing line 6e. The sample source 4 may, itself, comprise several components. These components, which are not specifically illustrated to avoid unnecessary drawing complexity, may include one or more sample containers, one or more solvent containers, a valve or mixing apparatus, a sample injector, as well as various sections of tubing.

The valve system 5 may comprise a plurality of multiple-port valves fluidically interconnected to one another, to the two pumps and to the two columns by means of various connection tubing lines. For instance, the illustrated valve system 5 comprises two multiple-port rotary valves v1, v2 such as the valves known as Rheodyne valves sold by IDEX Health & Science, 619 Oak Street Oak Harbor, Wash. USA. The valve system 5 shown in FIG. 1 is capable of transferring a portion of sample fluid to the first column 7a along fluid tubing line 6f, isolating and concentrating a sub-group of sample constituent substances on the first column 7a while other unwanted constituents are transferred to waste 14 along fluid tubing lines 6g and 6h, mixing the isolated and concentrated constituents with solvent fluids or a mobile phase in valve v2, transferring the isolated and concentrated sub-group of constituent substances to the second column 7b along fluid tubing line 6j and causing the sub-group of constituent substance to flow through the second column 7b so as to be further separated therein. The separated chemical constituents eluting from the second column 7b are transferred to the detector 31 along fluid tubing line 6k. The fluid tubing lines 6f and 6g are both shown with bi-directional arrows because, under some circumstances, sample fractions previously concentrated in the first cleanup column 7a may be released from the column and transferred back to the valve system 5 by back-flushing the column with solvent in the reverse flow direction from that used to load the column.

The system 10 may further comprise an electronic controller or computer apparatus 32 under software or firmware control that is electronically connected to various other system components by electronic communication lines, schematically shown as dashed lines in FIG. 1. For instance, electronic communication line 34a may be used to send operating control instructions to the detector 31 as well as to receive data from the detector. Electronic communication lines 34b and 34e may be used to send operating control instructions to the second pump 11b and first pump 11a, respectively. Similarly, electronic communication lines 34c and 34d may be used to send operating control instructions to the pair of valves v1, v2 and to the valve 9 (if present), respectively.

Although a conventional multiple column system, as described above, is capable of obtaining excellent analytical results, it does present a number of actual or potential issues and difficulties about which an analyst must be wary. A first potential difficulty arises from the experimental observations that the cleanup and analytical chromatography columns often need to be matched for optimal analytical results of a particular analyte from a particular type of sample. Various stationary phase materials are available for packing into each of the cleanup and analytical columns. It is often found that best results are obtained, for a given analyte and sample, with a particular combination of cleanup column and analytical column stationary phases (and mobile phases). The most-suitable matching column pair can conceivably vary from one analysis protocol to another. Thus, an analyst must take care to ensure that both the cleanup and analytical columns are appropriate for the analysis at hand and must take care to ensure that both columns are appropriately matched (and possibly replaced) when a new analysis protocol is started. A second potential issue arises from the fact that, since the multiple columns of a conventional multi-column system are not physically integrated with one another, time must be expended to separately replace both columns when a new protocol is started that requires a completely new pair of columns.

A third potential concern arises from the fact that the conventional columns do not carry on-board information on their usage history. This concern arises because chromatography columns have finite useful lifetimes. Thus, existing columns on the conventional system must be occasionally removed and replaced with fresh columns. The analyst must therefore take care to record hours used or the total number of analyses performed for each column Although such usage history records could be maintained by an electronic controller or computer apparatus, there is a risk of such information being lost if a column is transferred from one chromatography system to another. All of the above issues provide opportunities for errors to be introduced into the analyses with possible consequent invalidation of results.

### DISCLOSURE OF INVENTION

To address the above-noted issues, the present disclosure provides a modular chromatography cartridge comprising a housing having at least two chromatography columns at least partially contained therein. The columns are preferably but not necessarily affixed to the housing. Two columns in each cartridge may be matched for purposes of conducting chromatographic separations of a specific analyte (or analytes). For instance, a first column may comprise a TurboFlow® or other pre-column or cleanup column (such as a Solid Phase Extraction column or an affinity chromatography column) while a second column is an analytical column Connection fittings protruding outside of the housing at each end of each column enable fluidic connection to a chromatograph plumbing system and/or a detector such as a mass spectrometer. The cartridge may optionally comprise heaters and temperature sensors for temperature control of one or more columns as well as optional sensors to monitor fluid flow rate, pH, etc., together with associated electronic connectors. A passive identification feature (an indicator or identifier), e.g., a barcode or RFID module may be employed to identify the cartridge and its associated chromatography methods to external apparatus/software. Further, an on-board memory module and controller chip may be used to actively record computer-readable module information, including module history information, the information transferable through a standard interface, such as a universal serial bus (USB) port.

The connection fittings of the cartridge may provide quick connect/disconnect functionality at each end of each column housed therein, so that modules directed to analyses of different respective analytes may be rapidly interchanged. Each column connection fitting may mate with an inventive device that guides a fluid-carrying tube into the respective column end fitting such that the tube will be in contact with the column end fitting; applies a spring force to the tube which exceeds the opposing force that will be created when the column is at maximum operating pressure; and ensures that a deformable sealing member (which may be a ferrule) comes in contact with the same column end fitting, encircling the tube. Separate spring forces are applied to the tube and to the sealing member. The latter spring force ensures that a proper fluid seal is made between the tube, sealing member and column end fitting to prevent any leakage at the maximum operating pressure of the column. The positioning of the tube, sealing member, and column end fitting and the spring forces for the tube and sealing member may be provided for by a lever which provides an appropriate amount of motion and mechanical advantage such that an operator does not require a tool to insert or extract a cartridge.

In accordance with a first aspect of the invention, there is disclosed a cartridge for liquid chromatography separations comprising: a housing; and at least a first and a second chromatography column at least partially passing through the housing, each chromatography column comprising a first and a second end fitting operable to connect the chromatography to external tubing.

In accordance with a second aspect of the invention, there is disclosed a cartridge for liquid chromatography separations comprising: (a) a housing; (b) a first chromatography column at least partially passing through the housing, comprising: (i) a first and a second end fitting of the first chromatography column operable to connect the first chromatography column to external tubing; (ii) a packing material formed as a substantially uniformly distributed multiplicity of rigid, solid, porous particles having substantially uniform mean cross-section dimensions or diameters of not less than about 30 μm; and (iii) a system of interstitial channels between said particles having a total interstitial volume of not less than about 45% of the total volume of the column, wherein the particles and interstitial channels are configured such that, in operation, flow within at least a major portion of the interstitial volume is turbulent; and (c) a second chromatography column at least partially passing through the housing, comprising: (i) a first and a second end fitting of the second chromatography column operable to connect the second chromatography column to external tubing; and (ii) a packing material different from the packing material of the first chromatography column.

In a third aspect of the present invention, there is disclosed a liquid chromatography system comprising: (a) a sample source; (b) a solvent source; (c) at least one fluid pump fluidically coupled to the sample source and to the solvent source for propelling samples from the sample source and solvents from the solvent source through the liquid chromatography system; (d) at least one mixing apparatus fluidically coupled to the at least one fluid pump for mixing samples from the sample source with solvents from the solvent source; (e) a cartridge comprising: (i) a housing; and (ii) a first and a second chromatography column at least partially passing through the housing; (f) a valve system fluidically coupled to the first and second chromatography columns and to the at least one mixing apparatus; and (g) a detector fluidically coupled to the second chromatography column for detecting substances eluting from the second chromatography column, wherein the valve system is configurable so as to route fluids to the first chromatography column so as to be input thereto and so as to route fluids output from the first chromatography column to the second chromatography column so as to be input thereto.

### BRIEF DESCRIPTION OF DRAWINGS

The above noted and various other aspects of the present invention will become apparent from the following description which is given by way of example only and with reference to the accompanying drawings, not drawn to scale, in which:

FIG. 1 is a schematic illustration of a generalized conventional multiple-column liquid chromatography (LC) system;

FIG. 2 is a schematic illustration of a multiple-column LC system in accordance with the present teachings;

FIG. 3A is a schematic illustration of a two-column chromatography cartridge according to various aspects of the present teachings;

FIG. 3B is a schematic illustration of another two-column chromatography cartridge according to various aspects of the present teachings;

FIG. 3C is an overhead perspective view of still another two-column chromatography cartridge according to various aspects of the present teachings;

FIG. 3D is an underneath perspective view of the two-column chromatography cartridge of FIG. 3C;

FIG. 4A is an illustration of an apparatus for coupling a tubing to an end of a chromatographic column in accordance with various aspects of the present teachings;

FIG. 4B is a perspective view of the column securing mechanism portion of FIG. 4A;

FIG. 5A is an illustration of a portion of a second apparatus for coupling a tubing to an end of a chromatographic column in accordance with various aspects of the present teachings;

FIG. 5B is an illustration of a portion of a third apparatus for coupling a tubing to an end of a chromatographic column in accordance with various aspects of the present teachings;

FIG. 6A is a first perspective view of a fourth apparatus for coupling a tubing to an end of a chromatographic column in accordance with various aspects of the present teachings;

FIG. 6B is a second perspective view of the apparatus illustrated in FIG. 6A;

FIG. 6C is a cross sectional view taken through the center of and along the main axis of the apparatus illustrated in FIGS. 6A, 6B;

FIG. 7 is an illustration of a first system for coupling an input tubing and an output tubing to respective ends of a each one of two chromatographic columns of a two-column cartridge in accordance with various aspects of the present teachings; and

FIG. 8 is an illustration of another system for coupling an input tubing and an output tubing to respective ends of a each one of two chromatographic columns of a two-column cartridge in accordance with various aspects of the present teachings.

### MODES FOR CARRYING OUT THE INVENTION

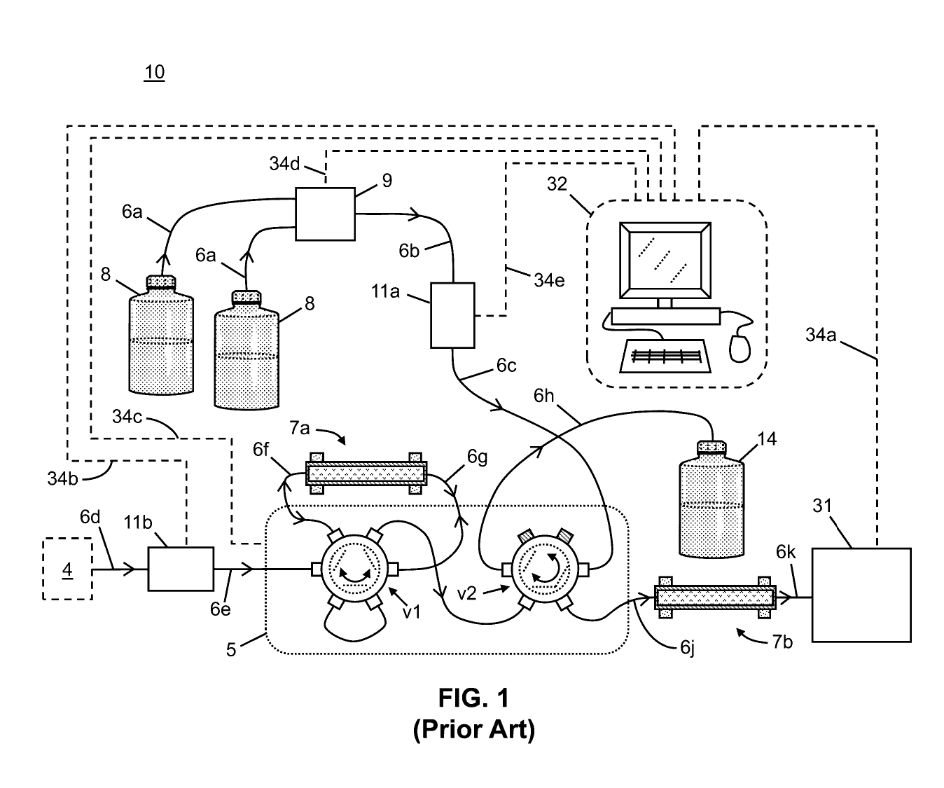

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. To appreciate the features of the present invention in greater detail, please refer to FIGS. 1-6 in conjunction with the following discussion.

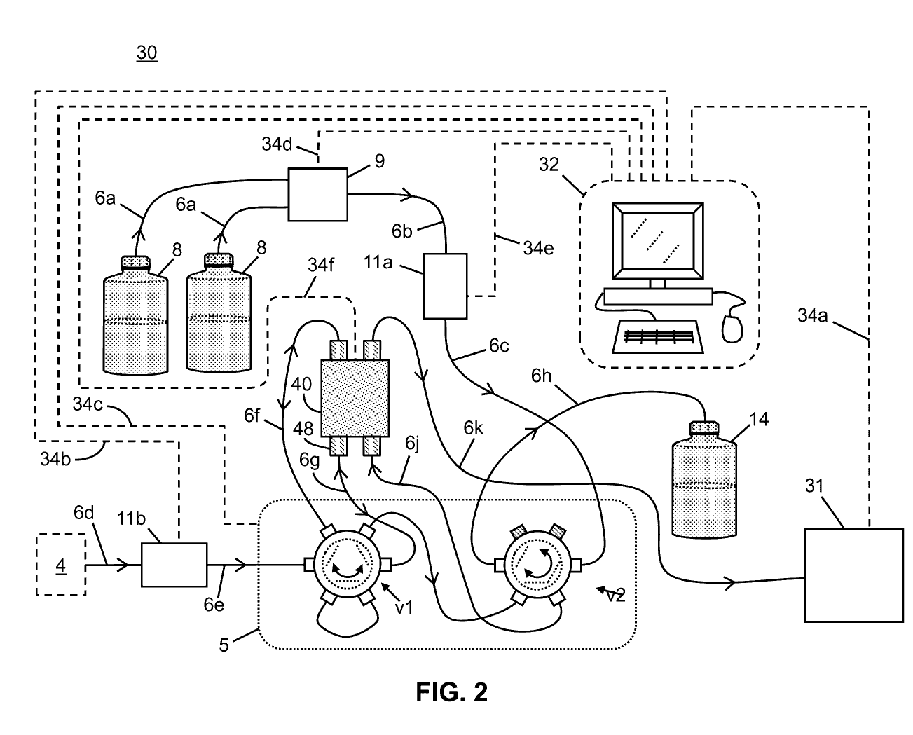

Although the conventional system 10 illustrated in FIG. 1 is capable of obtaining excellent analytical results, it does present a number of actual or potential issues and difficulties as previously noted above. Accordingly, FIG. 2 provides a schematic illustration of an improved system in accordance with various aspects of the present teachings. Like reference numbers in FIGS. 1-2 refer to like components in the system 10 (FIG. 1) and the system 30 (FIG. 2). Comparison of the two figures shows that the two discrete columns 7a, 7b of the system 10 are replaced by the single integrated cartridge 40 of the system 30. The cartridge 40 of the system 30 contains therein both a first column analogous to the cleanup column 7a of FIG. 1 as well as a second column analogous to the analytical column 7b of FIG. 1.

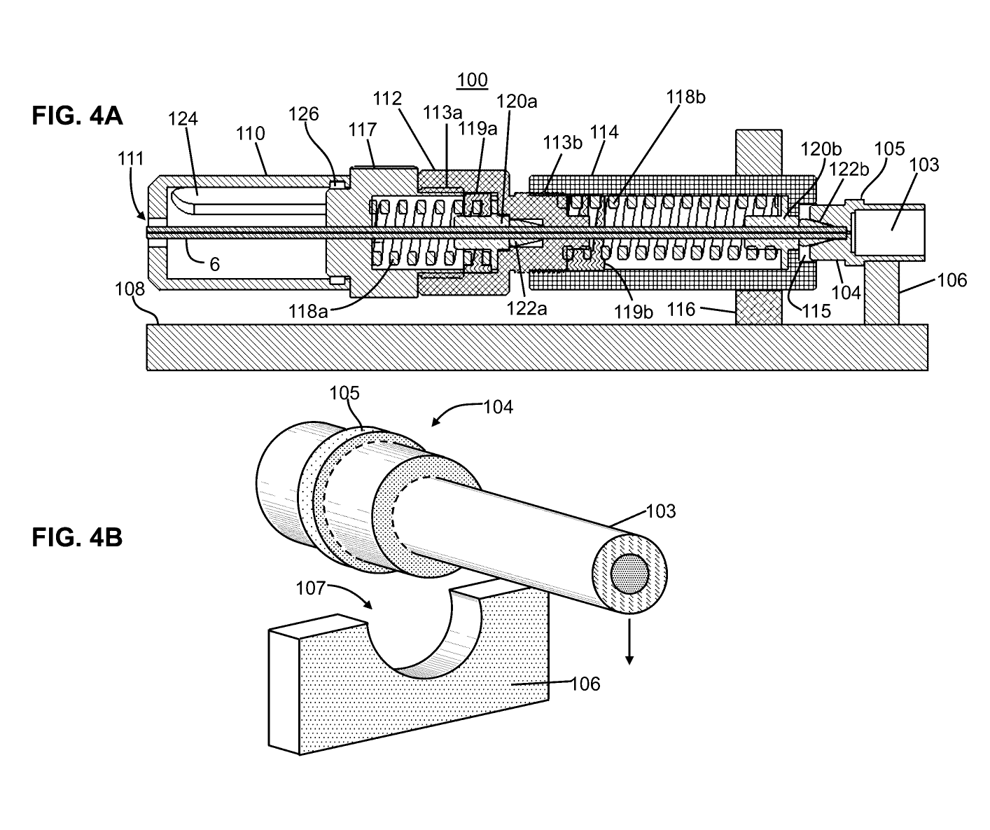

Connectors 48 are employed in order to connect the two end fittings of the first column of the cartridge 40 to fluid tubing lines 6f and 6g as well as to connect the two end fittings of the second column of the cartridge 40 to fluid tubing lines 6k and 6j. Each connector 48 may comprise a simple conventional tubing connection fitting or end fitting consisting of just a coupling nut, a tubular coupling body and a ferrule. However, in accordance with various aspects of the present teachings, the connectors 48 may comprise alternative apparatuses designed so as to not require an installation tool and so as to prevent application of a twisting motion or torque. Examples of such apparatuses are illustrated in the appended FIGS. 4-6 and discussed in greater detail following. The columns within any individual cartridge may be matched with one another so as to provide optimum chromatographic separation for a particular type of analysis, a particular analysis protocol, or a particular type of sample. Optimal separation or concentration of any particular analyte may require a particular combination of cleanup and analytical column properties (e.g., chemical or physical makeup of the stationary phase). The utilization of two columns within a single cartridge thus enables two columns of a matched set (within a first cartridge) to be rapidly swapped out and replaced with a matched pair of columns (within a second cartridge) that are better suited to a subsequently run analysis or analysis protocol.

The provision of the cartridge 40 in the system 30 (FIG. 2) enables not only quick interchange of matched sets of columns but also the inclusion of on-board cartridge electronics or electronically controlled components that relate to cartridge operation or that store or manipulate data relating to the cartridge. For instance, the cartridge may comprise components that relate to controlling a column environmental variable, such as temperature, during the course of a chromatographic separation for purposes of controlling the separation. In addition or alternatively, the cartridge may comprise one or more sensors or transducers that monitor an environmental or operational parameter that relates to the functioning of one or more columns of the module, such as temperature, fluid pressure or fluid flow rate. In addition or alternatively, the cartridge may comprise an electronic memory storage device that may store data relating to the cartridge identity; the types of columns housed within the cartridge; the nature of any analytical protocols for which the cartridge is designed; and possible historical cartridge usage data such as number of hours operated, number of analyses performed or time profiles of temperature, pressure or flow-rate recorded by any on-board sensors.

In accordance with the above considerations, the module may comprise, in addition to the fluid connections, an electronic connector or other electrical connector that enables communication between the cartridge 40 and the controller or computer apparatus 32 by means of an electronic communication line 34f (FIG. 2). The electronic communication line 34f may provide two-way communication. For instance, software of the controller or computer apparatus 32 may read cartridge identification information from the cartridge so as to verify that the correct cartridge is in use for the current analysis protocol and to check that an attempt is not being made to use the cartridge beyond its nominal useful lifetime. Alternatively, or in addition, the controller or computer apparatus 32 may send control signals to the cartridge 40 so as to operate one or more operational control devices of the cartridge, such as a column heater.

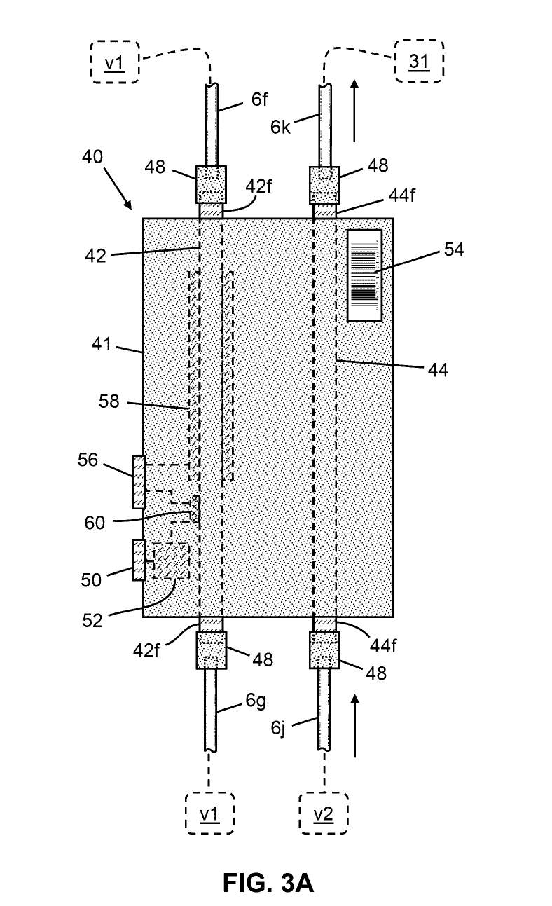

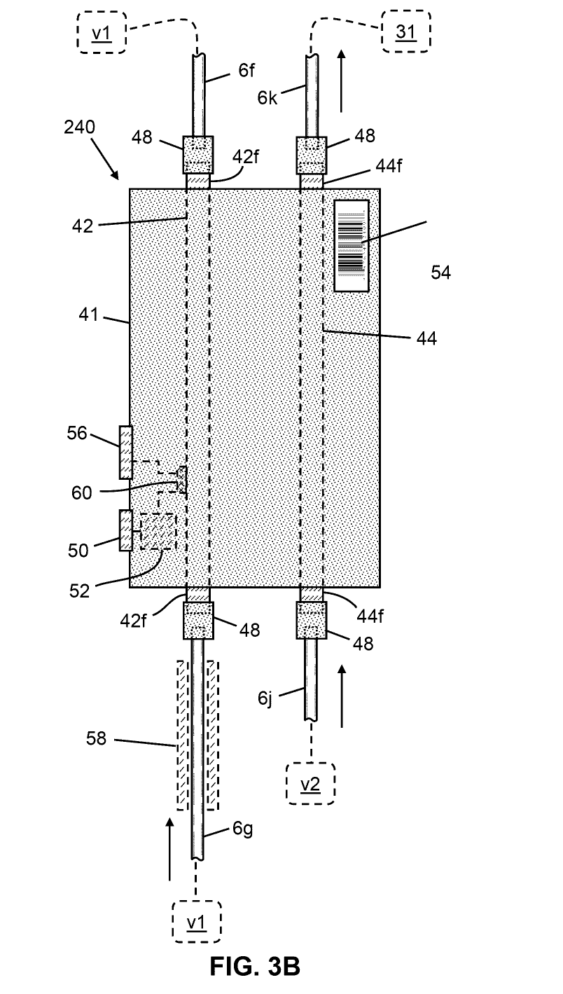

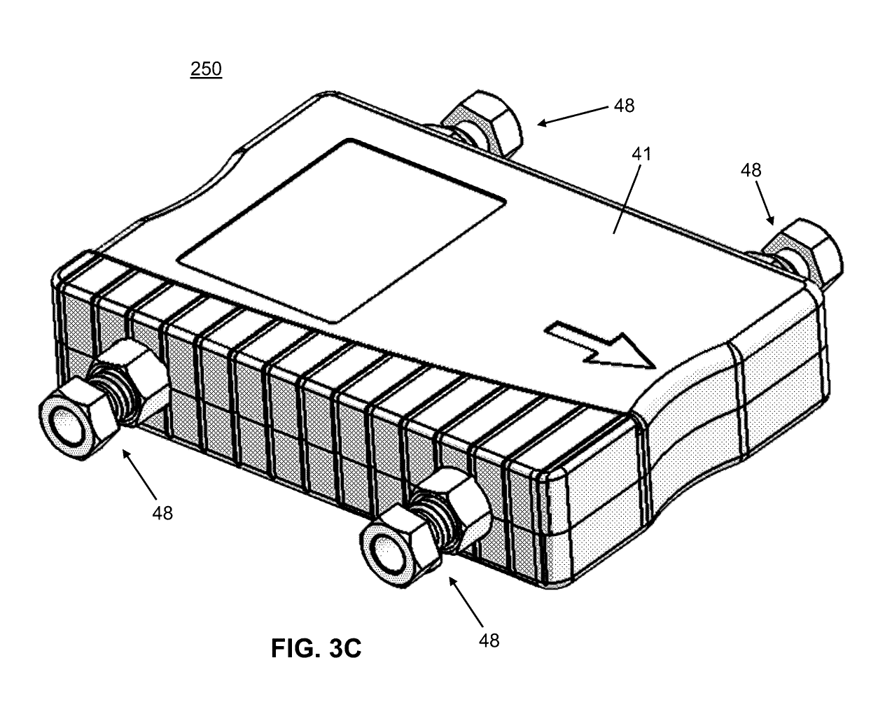

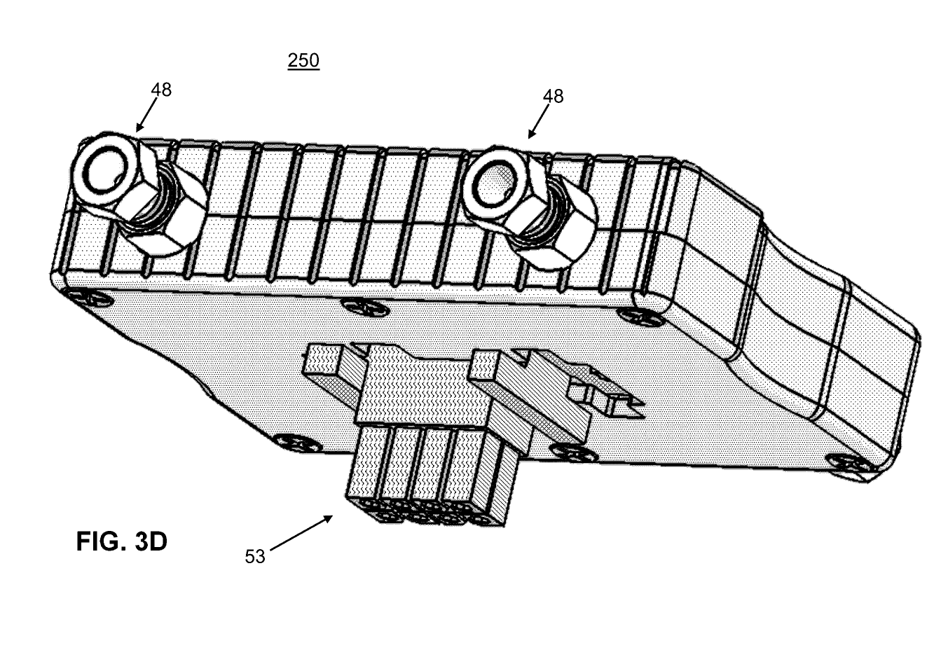

FIG. 3A is a schematic illustration showing additional details of a dual-column chromatography cartridge in accordance with the present teachings. The chromatography cartridge 40 comprises a housing 41 having two chromatography columns—a first column 42 and a second column 44—at least partially contained therein. Preferably, but not necessarily, the columns 42, 44 are affixed to the housing 41. The two columns in each cartridge may be matched for purposes of conducting chromatographic separations of a specific analyte (or analytes). For instance, the first column 42 may comprise a cleanup column such as a TurboFlow® or HTLC column while the second column 44 may comprise an analytical column. The first column 42 comprises two column end fittings 42f with one such end fitting at each of the two column ends. Likewise, the second column comprises an end fitting 44f at each of its two ends. As is known, column end fittings are attachment points for fluidic connections to external tubing. Accordingly, connectors 48 are employed in order to connect the two end fittings of the first column 42 to fluid tubing lines 6f and 6g as well as to connect the two end fittings of the second column 44 to fluid tubing lines 6k and 6j, these external tubing lines being similar to those shown in FIG. 2. As previously noted, the two tubing lines 6f and 6g both connect, at their opposite ends to rotary valve v1 and may direct flow in either direction through the first column 42, depending on whether the column is being loaded or flushed. The tubing lines 6j and 6k are, respectively, fluid input and output lines with respect to the second column 44 with line 6j providing fluid to the second column from the rotary valve v2 and line 6k outputting eluting analytes to the detector 31. Note that the fluid tubing lines 6j, 6k could also be coupled to the column ends of the second column 44 in an opposite sense to that shown in FIG. 3A such that fluid flow through that column would be in the opposite direction to that shown.

The cartridge 40 may include a passive identification feature (an indicator or identifier), e.g., a barcode 54 or an RFID module, etc. that may be employed to identify the cartridge and its associated chromatography methods to external apparatus/software. For instance, the system 30 may include a barcode reader (not shown) or other apparatus capable of interpreting the passive identification feature, the reader or other apparatus being electronically connected to the electronic controller or computer apparatus 32. This feature may enable system software to be able to automatically verify that the columns within an inserted cartridge are appropriate for an analysis protocol currently being conducted by the system.

The cartridge 40 may further or alternatively include various electronic control, sensing, data storage or logic components together with associated external electronic connectors. For example, the cartridge may include one or more heaters 58 in intimate contact with one or more of the contained columns so as to control temperature during a chromatographic procedure. The heater may be used, for instance, to increase temperature so as to release a sample fraction previously retained or concentrated on a stationary phase within the first column so that the sample fraction may be transferred to the second column. The cartridge may include one or more temperature sensors 60. Such sensors, if present, may work in conjunction with any on-board heaters as part of a temperature control loop to control the temperature of one or more columns. The control logic may be implemented in software of the electronic controller or computer apparatus 32 or, alternatively, may be implemented in firmware of an on-board circuitry module 52 which may comprise electronic memory or controller logic. In addition or alternatively, the circuitry module 52 may be used to actively record computer-readable data or other information pertaining to the module, including module history information, such information downloadable by or transferable to external apparatus (such as electronic controller or computer apparatus 32) through a standard interface 50, such as a USB port. Other electrical or electronic connectors 56 may be employed to provide power to heaters, to read sensors, etc.

FIGS. 3B-3D illustrate alternative chromatography cartridges in accordance with the present teachings. The cartridge 240 shown in FIG. 3B is similar in most respects to the cartridge shown in FIG. 3A, except that the heater 58 is eliminated from the interior of the housing 41 and, instead, disposed in contact with or in close proximity to an inlet tubing (note the arrow adjacent to tubing line 6g indicating the direction of fluid flow) such that the fluid is pre-heated prior to entering the column 42. A similar heater could be similarly disposed with regard to the other column 44 depending upon experimental requirements. Depending upon the rate of fluid flow, the configuration illustrated in FIG. 3A may not allow sufficient time for the fluid within the column to achieve the desired temperature. However, the heater configuration shown in FIG. 3B may be arranged so that the fluid is in contact with the heated length of tubing for a sufficient time so as to achieve the desired temperature within the column. The heater 58 shown in FIG. 3B could comprise any of a several heating devices such as a coiled resistance wire or commercially available heating tape. If desired, the tubing heater may supplement the internal heater illustrated in FIG. 3A. One or more temperature sensors 60 may remain in contact with one or both columns inside the cartridge so as to provide a measurement of the temperature(s) of fluids in the column(s) and possibly so as to provide temperature feedback for controlling the heater.

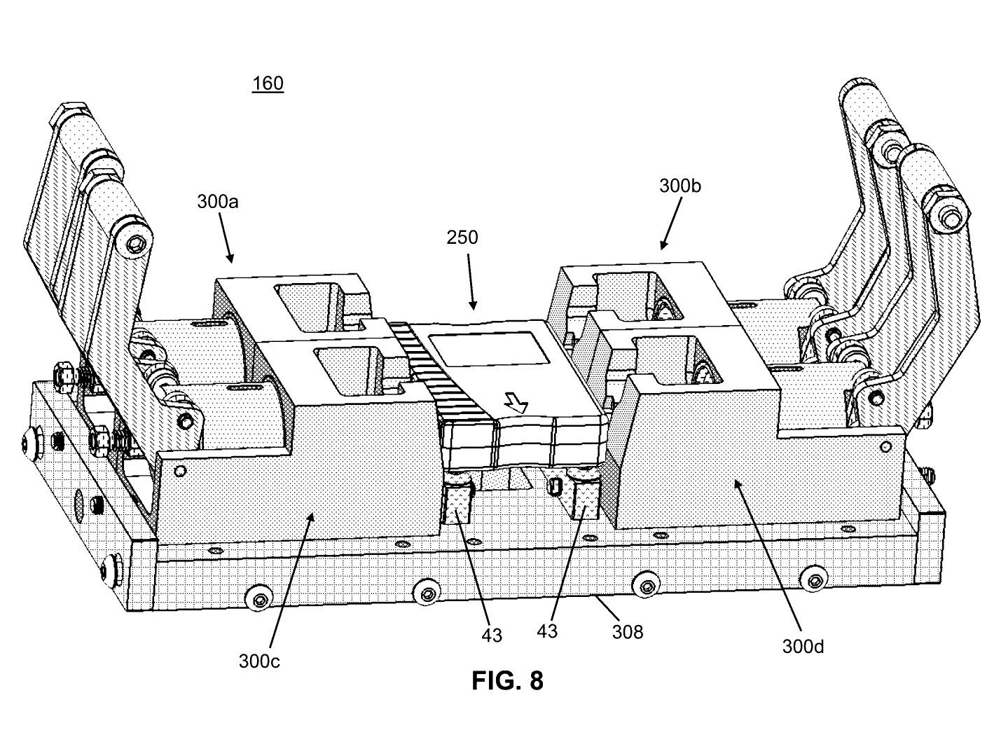

The cartridge 250 depicted in FIGS. 3C-3D comprises a different aspect ratio from the cartridges shown in FIGS. 3A-3B. In many situations, it may be desirable to fabricate the cartridge so as to allow the user to simply, with one motion, insert the cartridge into a holder or cradle such that electrical connections to the cartridge are made at the same time that correct cartridge positioning is achieved. Accordingly, the cartridge 250 comprises a single electrical connector port 53 that replaces and provides the functionality of both the standard interface port 50 and the separate electrical connector 56 shown in FIGS. 3A-3B. The connector port 53 is shown on the underside of the cartridge 250, in this example, since it may be advantageous for the user to insert a cartridge by pushing it downward into position, as in the system shown in FIG. 8, discussed below. The single downward motion will then both align the cartridge and cause the connector port 53 to make contact with a mating connector in, for instance, a base plate. Other connector port and insertion configurations are also possible.

As an example of a two-stage chromatographic separation, a TurboFlow® column (also sometimes know as a High Turbulence Liquid Chromatography or HTLC column) may be employed, in certain embodiments in accordance with the invention, as a “cleanup” column in a first separation step. The TurboFlow column may be employed to isolate and possibly concentrate a subset of compounds based on their size range or molecular weight range (or some other property) and then a following “analytical column” may be employed to separate the individual compounds of the isolated or concentrated subset. TurboFlow® methods and apparatus are described in detail in U.S. Pat. Nos. 5,772,874; 5,919,368 and 6,149,816, all of which are hereby incorporated by reference in their entirety as if fully set forth herein. Briefly stated, the TurboFlow® apparatus and methods include or relate to a chromatography column or body that is formed as a substantially uniformly distributed multiplicity of rigid, solid, porous particles having substantially uniform mean cross-section dimensions or diameters of not less than about 30 μm, typically 50 μm or greater up to, but not limited to, 1000 μm in certain instances. The particles are selected from a range of various sizes and shapes and are held together in a body or column as by pressure, sintering and the like so that interstitial channels having a total interstitial volume of not less than about 45% of the total volume of the column are formed between the particles. The surfaces of the particles, including the inner surfaces of the pores in the particles, are chromatographically active, as by being coated with chromatographic stationary phase layers.

Because of the nature of the particles and packing in a TurboFlow® column, the flow of the fluid mixture through the column can be at a high flow rate and is believed that, under such conditions, turbulent flow of the mixture is induced within at least a major portion of the interstitial volume, and it is postulated that such turbulent flow in fact enhances the rate of mass transfer, thus increasing the dynamic capacity of the column From the principles of turbulence, diffusion, and chemistry, small sample molecules may be separated from a sample matrix in a TurboFlow® column. Since small molecular weight molecules diffuse faster than large molecular weight molecules, the small sample compounds diffuse into the particle pores. The turbulent flow of the mobile phase quickly flushes the large sample compounds through the column to waste before they have an opportunity to diffuse into the particle pores. Of the sample molecules that enter the pores, those that have an affinity to the chemistry inside the pores bind to the internal surface of the column particles. The small sample molecules that have a lower binding affinity quickly diffuse out of the pores and are flushed to waste. A change in mobile phase, temperature or other parameter may then cause those molecules that were bound by the TurboFlow® column to elute to the analytical column for further separation.

In various other embodiments of the invention, either a Solid Phase Extraction (SPE) column or an affinity chromatography column may be employed as a cleanup column. An SPE column may be used to eliminate or separate out certain non-analyzed or interfering chemical constituents based upon their physical or chemical tendancy to either be held within (or upon) or to pass through a stationary phase material. The interfering constituents may be either suspended or dissolved in the mobile phase. An affinity chromatography column can also to eliminate certain non-analyzed or interfering chemical constituents but, in this latter case, the elimination or separation is based on the relative tendancies of sample constituents to undergo biological interaction with the stationary phase. The biological interaction may, for instance, be a specific interaction between an antigen and an antibody or between an enzyme and the biological material upon which the enzyme specifically interacts.

In one type of experiment, the analyte or analytes of interest may be held within the cleanup column (HTLC, SPE, affinity chromatography or other) while the interfering constituents pass through the cleanup column to waste. A subsequent change of mobile phase solvent (or a change of one or more physical parameters, such as temperature) may then be used to extract the analytes of interest and direct them to the analytical column. In another type of experiment, the analyte or analytes of interest may pass through the cleanup column and then pass to the analytical column while the interfering constituents are held within the cleanup column. A different solvent or a change of one or more physical parameters may be subsequently employed to flush the separated unwanted constituents out of the cleanup column to waste. The analytical column may be a column that separates the various analytes and other constituents based upon the differing retention times within the analytical column Optimal separation or concentration of any particular analyte may require a particular combination of cleanup and analytical column properties (e.g., chemical or physical makeup of the stationary phase).

FIG. 4A is an illustration of a first exemplary connector apparatus 100 for coupling a tubing to an end of a chromatographic column in accordance with the present teachings. In some embodiments, the apparatus 100 may be employed as one or more of the connectors 48 (FIGS. 2, 3). Such apparatus may be employed to facilitate quick connection and disconnection of the cartridge 40 from the system 30 shown in FIG. 2. The apparatus shown in FIGS. 4A-4B is described in greater detail in an International (PCT) application for patent titled “Apparatus and Method for Coupling Tubing to Chromatographic Column” (Attorney Docket No. 5806WO1/PCT, Application No. PCT/US2011/058226) filed on Oct. 28, 1011 and published as WO 2012058513 A1, said application incorporated herein by reference in its entirety. In operation, a tubing 6 passes completely through the connector 100 substantially parallel to an axis of the apparatus through various apertures 111 of the apparatus. The apparatus 100 is operable so as to apply a force to the tubing 6 so that the tubing is pressed into a column end fitting 104 so as to form a fluid coupling with the column 103. The apparatus 100 is further operable so as to apply a second force to a deformable sealing member 122b (such as a ferrule) so as to deform the sealing member in a fashion that creates a leak-tight seal between the tubing 6, end fitting 104 and column 103. Both such forces are applied substantially parallel to the common axis of the apparatus 100 and the column 103, thereby preventing application of any twisting motions or forces to the column.

The connector apparatus 100 shown in FIG. 4A comprises a hollow distal (or outer) body member 110, a hollow intermediate body member 112 and a hollow proximal (or inner) body member 114 where the terms “distal” and “proximal” refer to spatial relationships taken with respect to a chromatograph column 103 having a column end fitting 104. The distal body member 110 is attached to the intermediate body member 112 by a first threaded coupling 113a and the intermediate body member 112 is attached to the proximal body member 114 by a second threaded coupling 113b. The assembled body members are supported, as a group, on a base or housing 108 by a support member 116 which is either affixed to or rigidly clamped onto the proximal body member 114. The column 103 is supported by a column support member 106 which fits at least partially around the column end fitting 104 as shown in FIG. 4B.

The support member 116 of the apparatus 100 (FIG. 4A) is engaged to the base or housing 108 so as to be moveable, in substantially one direction only, with respect to the housing. Such slidable engagement may be implemented, for instance, by the use of a rail (not shown). Such a rail could be rigidly attached to the support member and designed so as to slide within a matching groove (not shown) in the base or housing. One of ordinary skill in the mechanical arts could readily devise other slidable engagement configurations and couplings.

In contrast to the slidable nature of the coupling between the support member 116 and the base or housing 108, the column support member 106 is rigidly fixed in place with respect to the base or housing 108. As shown in FIG. 4B, the column support member 106 comprises a salient or re-entrant portion 107 which is designed to mate with and partially enclose a portion of the column end fitting 104. Either the column end fitting or the column support may be constructed of a slightly pliable material such that the end fitting 104, together with the column 103, “snaps” into a defined and reproducible position within the salient 107 when the column is moved, under force, in the direction of the downward pointing arrow of FIG. 4B. A stopping mechanism of the column end fitting 104, such as circumferential ridge 105, prevents movement of the end fitting and column when force is applied to the free end of the column by the apparatus 100 during the operation of coupling a tubing 6 to the column Although the stopping mechanism is illustrated as a circumferential ridge 105 in FIG. 4B, it could alternatively be implemented as a different form of protrusion, such as a boss, knob or pin. The combination of the slidable coupling between the support member 116 and the base or housing 108 and the fixed coupling between the column support member 106 and the base or housing permits the apparatus 100 (comprising the assembly of three body members 110, 112, 114 and associated components further discussed following) to be moved towards or retracted from the column 103 and its associated column fitting 104 by movement parallel to an axis of the apparatus 100. Optionally, the slidable coupling may be provided with a locking mechanism to prevent movement when a desired position is achieved.

Returning now to the discussion of FIG. 4A, it may readily be observed that the apparatus 100 further comprises two springs assembled within the apparatus so as to provide separate spring forces parallel to an axis of the apparatus. A first spring 118a is disposed within a first interior portion of the apparatus defined between the intermediate body member 112 and an end cap 117 of the distal body member 110. A second spring 118b is disposed within a second interior portion of the apparatus defined between the intermediate body member 112 and the proximal body member 114. The first spring 118a is held against a first bushing or washer 120a by a first spring retainer 119a. Likewise, the second spring 118b is held against a second bushing or washer 120b by a second spring retainer 119b. During assembly, the first spring 118a is pre-loaded with a first pre-determined spring force, by progressive engagement of the first threaded coupling 113a, so as to supply the first pre-determined spring force between the end cap 117 and the bushing or washer 120a. Likewise, during assembly, the second spring 118b is pre-loaded with a second pre-determined spring force, greater than the first pre-determined spring force, by progressive engagement of the second threaded coupling 113b, so as to supply a second pre-determined spring force between the intermediate body member 114 and the bushing or washer 120b.

Prior to assembly of the distal body member 110 onto the intermediate body member 114, a ferrule 122a is placed into a hollow interior portion of the intermediate body member. The purpose of the ferrule 122a is to transfer force provided by the first spring 118a through the bushing or washer 120a to the tubing 6 such that the tubing is pressed into the column end fitting 104 with sufficient force so that the pressure between the tubing and the end fitting exceeds the fluid pressure—typically 15000 psi—achieved in the column under normal operating conditions. Since the body of the tubing is generally constructed of metal, the ferrule 122a is preferably constructed of a metal—for instance, stainless steel—having a hardness that is equivalent to or greater than that of the tubing. With such choice of material, force applied to the ferrule 122a in the direction of the column 103 will tend to cause the ferrule 122a to wedge itself into the tubing wall so as create a tight metal-to-metal friction seal. In alternative embodiments, the ferrule 122a may be replaced by a shape on or integral with the tubing 6, such as a ridge, groove, ring, etc. In operation, the formed shape portion of the tubing may engage with a clamp, ring, washer, bushing etc. in contact with the first spring 118a in order to transfer spring force to the tubing 6.

In operation, the apparatus 100 also comprises a deformable sealing member 122b (which may be a ferrule), which is placed on the tubing 6 just prior to positioning the tubing end into the column end fitting 104. The purpose of the deformable sealing member or ferrule 122b is to deform, under application of force provided by the second spring 118b through the bushing or washer 120b so as to form a leak-tight seal between the tubing, end fitting and column. Accordingly, the deformable sealing member 122b is preferably constructed of an elastic polymer material such as PEEK.

When the apparatus 100 is not in operation providing coupling between a tubing and a column, the pre-loaded spring forces are respectively taken up between the end cap 117 of the distal body member 110 and the intermediate body member 112 and between the intermediate body member and the proximal body member 114. A user may place the apparatus 100 in operation (with the tubing 6 and the ferrule 122a already in place within the apparatus and the deformable sealing member or ferrule 122b already in place on the tubing) by operating a clamping and latching mechanism 124 (comprising both a pushing mechanism and a locking mechanism) which pushes the three body members (and, consequently, also the support member 116, the tubing 6 and the hardware within the body members) in the direction of the fixed column 103 and its end fitting 104.

Once the tubing comes into contact with the end fitting, further application of force (by continued operation of the clamping and latching mechanism) causes the tubing to apply an increasing force against the first spring 118a through the ferrule 122a and the first bushing or washer 120a. Once the opposing force provided by the tubing exceeds the pre-loaded spring force on spring 118a, continued operation of the clamping and latching mechanism will cause the spring to compress, thereby enabling movement of the apparatus such that the deformable sealing member 122b comes into contact with both the proximal body member 114 and the column end fitting 104. Further operation of the clamping and latching mechanism causes both compression of the first spring 118a as well as application of an increasing opposing against the second spring 118b through the deformable sealing member 122b and the second bushing or washer 120b. Still further operation of the clamping and latching mechanism causes both springs 118a, 118b to compress with consequent increase in spring force applied to the tubing and to the sealing member. The increasing force and pressure on the sealing member 122b causes this sealing member to deform within the column end fitting 104 and around the tubing so as to create a leak-tight pressure seal.

A recess 115 in the end of the proximal body member 114 may be provided so as to provide a gap for accommodation of the deformable sealing member 122b and to guide the relative movement between the connector apparatus 100 and the column end fitting 104 during the clamping and latching procedure. The pre-compression of the springs prior to actual operation of the apparatus ensures that minimal actual movement of parts is required to achieve the required or appropriate final forces on the tubing and on the deformable sealing member.

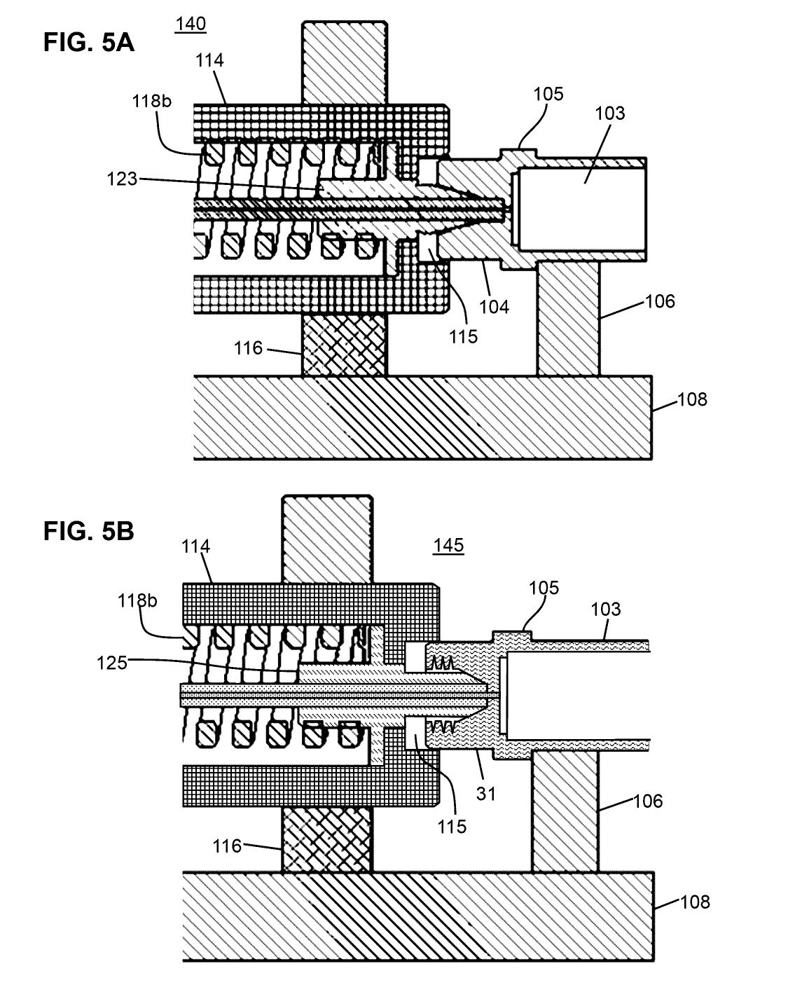

FIGS. 5A-5B are illustrations of end portions of two alternative apparatuses for coupling a tubing to an end of a chromatographic column in accordance with the present teachings and which, in some embodiments, may be employed as one or more of the connectors 48 (FIGS. 2, 3). The apparatuses 140, 145 shown in FIGS. 5A, 5B are similar, in most respects, to the apparatus 100 illustrated in FIG. 4A. However the apparatuses 140, 145 differ from the apparatus 100 in regards to the manner in which the tubing 6 is sealed to an end fitting 104, 31 and to the column 103. Whereas, in the apparatus 100, the deformable sealing member 122b may simply comprise a second ferrule, in the apparatus 140 shown in FIG. 5A, a single integral, single-bodied sealing member 123 replaces both the second bushing or washer 120b and the sealing member 122b. The sealing member 123 comprises a deformable material so as to create a leak-tight seal between the tubing 6, the end fitting 104 and the column 103 under force from the second spring 118b. In the apparatus 140 shown in FIG. 5A, another integral, single-bodied sealing member 125 is employed for such sealing purposes.

The sealing member 125 of the alternative apparatus 145 (FIG. 5B) is a modified version of the sealing member shown in FIG. 5A in which a portion extending outward from the proximal body member 114 is elongated, such that the tubing 6 can be sealingly coupled to a conventional column end fitting 31 using the novel coupling apparatus 145. Many conventional end fittings, such as the conventional end-fitting 31, have a bore with an internal screw thread. This internal screw thread is designed to mate with external threads of a threaded nut or screw that may be rotated so as to provide a compression force. Although such screw threads are not employed in the illustrated novel embodiments disclosed herein, it is nonetheless desirable to be able to employ the invention in conjunction with existing chromatographic columns having conventional fittings. Accordingly, the sealing member 125 has an elongated portion that has a diameter smaller than the internal diameter of the threaded portion of the end fitting 31. In this way, the sealing member 125 is adapted so as to extend into the conventional column end fitting without contacting the threads, thereby bypassing the threaded portion. Inward of the threads, the deformable sealing member 125 engages, in operation, with a tapered portion of the bore of the conventional end-fitting, thereby forming a leak-tight seal in a manner similar to the way in which the deformable sealing member or second ferrule 122b creates a seal against the un-threaded end fitting 104 (FIG. 4A). Upon disconnection of a tubing from a chromatographic column using either apparatus 140 or apparatus 145, the sealing member (either sealing member 123 or sealing member 125) may remain either attached to or within the proximal body member 114, thereby eliminating the requirement for a user to supply or insert a ferrule at the next use of the respective apparatus.

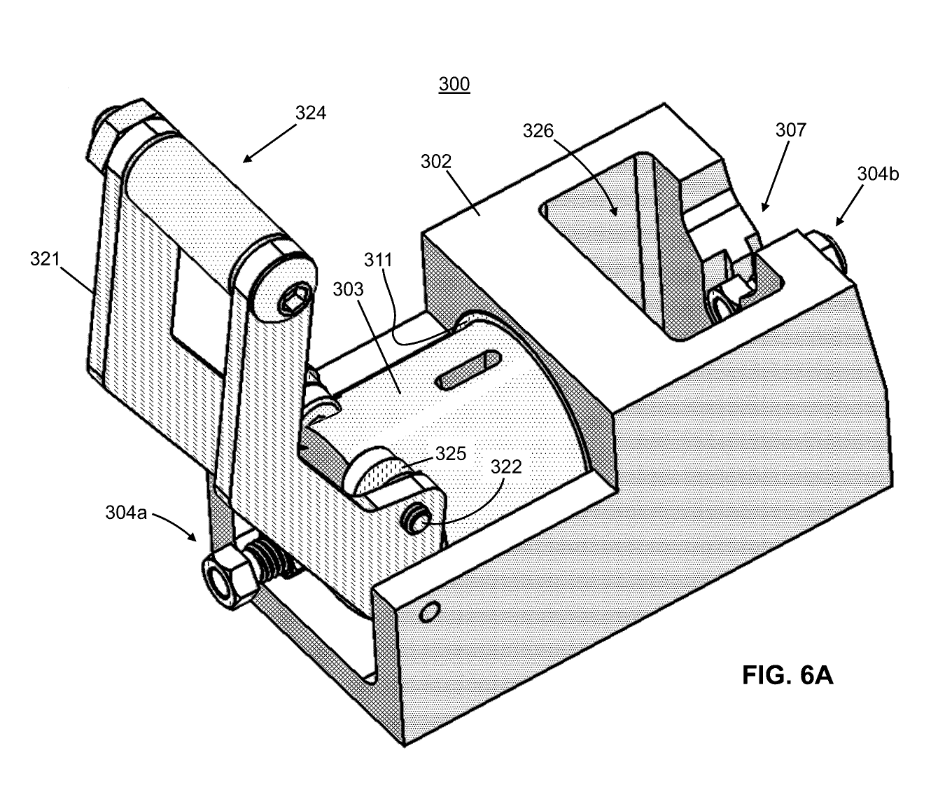

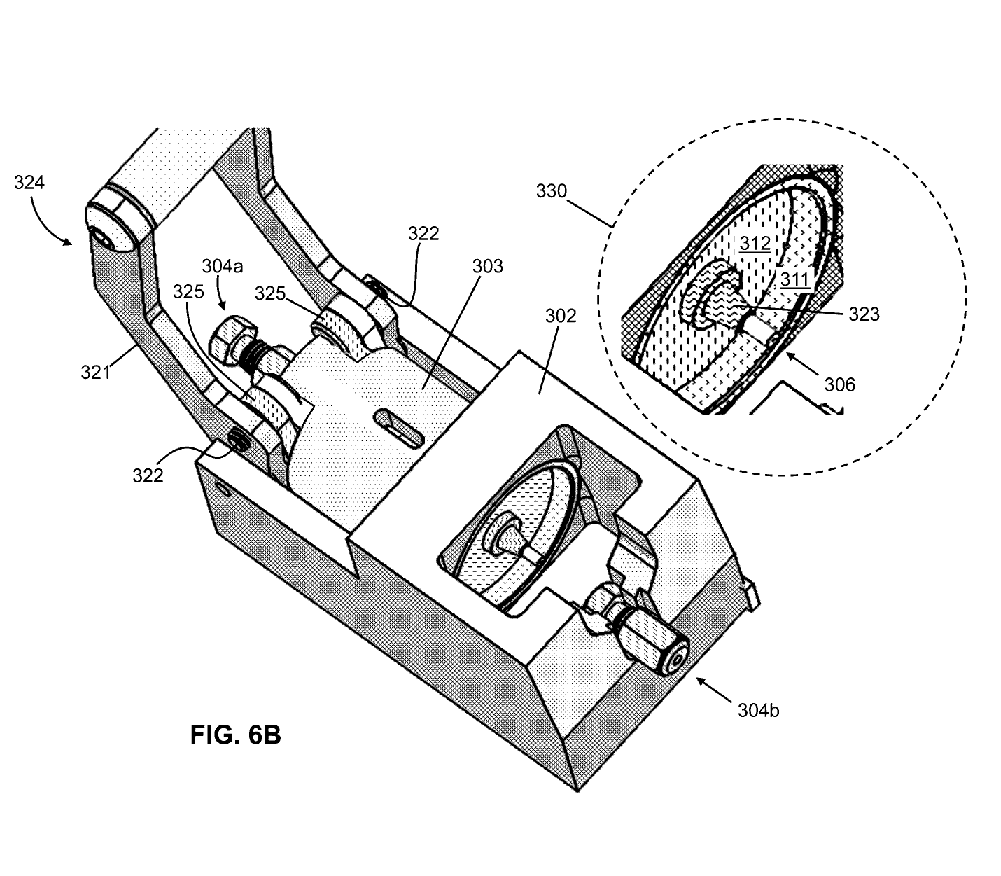

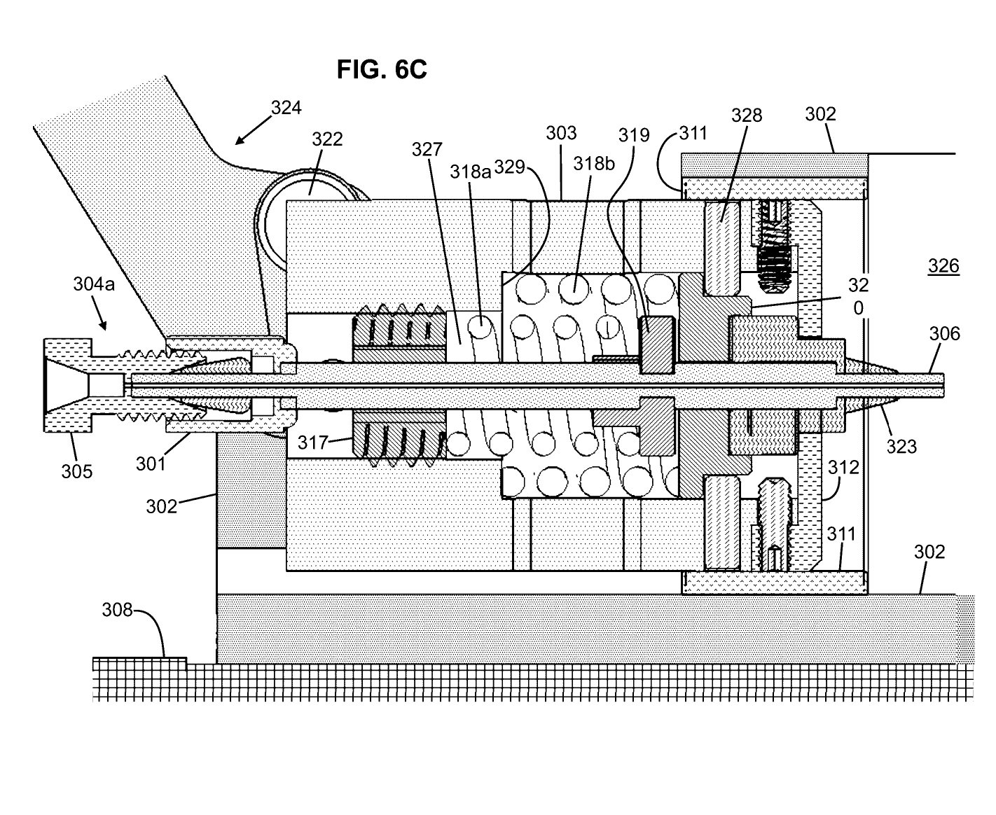

FIGS. 6A-6C depict another apparatus for coupling a tubing to an end of a chromatographic column in accordance with various aspects of the present teachings. In some embodiments, the apparatus 300 illustrated in FIG. 6 may be employed as one of more of the connectors 48 shown in FIGS. 2-3. Referring in detail now to the connector apparatus 300, FIGS. 6A and 6C are first and second perspective external views of the fully assembled apparatus 300. Considered generally, the apparatus 300 comprises a housing 302 that is a first body member of the apparatus and a piston 303 that is a second body member of the apparatus. The housing 302 has an open bore or cavity 326. The piston 303 is capable of being slidably inserted at least partially into the bore or cavity 326 of the housing and is also capable of being at least partially retracted from the bore or cavity. Preferably, a portion of bore or cavity 326 comprises a shape that mates with the portion of the piston which is capable of being slidably inserted into the bore or cavity. If this portion of the piston is cylindrical, then the piston and bore may be said to comprise a piston-cylinder relationship.

A bushing or other bearing 311 may be provided within the portion of the bore or cavity 326 that receives the portion of the piston 303 so as to provide a smooth sliding surface for insertion and retraction of the piston. The movement of the piston into or partial retraction of the piston from the housing may be controlled manually by a user by means of a pushing and latching (or locking) mechanism 324. As shown the pushing and latching mechanism may comprise a hand operated lever 321 and a coupling bar 325 such that the coupling bar 325 is mechanically engaged to the lever 321 by means of a first pivot pin 322 about which an end of the coupling bar is free to rotate. A second pivot pin (not shown) similarly provides mechanical engagement between the opposite end of the coupling bar 325 and the piston 303 so that rotational motion of the lever 321 is converted into translational motion of the piston.

The piston 303 has a chamber 327 therein through which a length of tubing 306 passes. The inset drawing 330 of FIG. 3B shows a portion of the apparatus 300 in magnified view so that an end portion of the tubing 306 may be seen protruding beyond an end plate 312 of the piston 303. A sealing member 323, which is a part of the apparatus and which may be a deformable ferrule, encloses a portion of the tubing 306 such that the end portion of the tubing protrudes partially beyond the sealing member 323. The sealing member 323 has a conical outer surface which is designed to mate with a conical inner surface of a conventional end fitting 304b (which is not necessarily a component of the apparatus 300 but which is shown for clarity) so as to provide a leak-tight seal within the end fitting 304b. In operation, the end-fitting 304b will generally be mounted on an end of a chromatograph column (not shown) which will be either an inlet end or an outlet end of the column. Accordingly, with the tubing 306 and sealing member 323 inserted into the end fitting 304b by means of the connector apparatus 300, the tubing 306 will either deliver fluid into or receive fluid from the chromatograph column.

In the views shown in FIGS. 6A, 6B, the connector apparatus is shown in an open position, such that the end of the tubing 306 is retracted from the end fitting 304b. In this open configuration, the chromatograph column may be removed or replaced. The same or a different chromatograph column may then be positioned in the correct placement so as to receive the end of the tubing 306 by positioning its end fitting into a slot, recess or groove 307 (FIG. 6A) of the housing 302. Thus, a portion of the housing comprising the slot, recess or groove 307 provides the same functionality as the column support member 106 discussed previously herein in conjunction with other embodiments. Subsequently, the pushing and latching mechanism 324 is operated so as to cause the piston 303 to move further into the bore or cavity 326 with the tubing 306 being carried along with such motion until the tubing end engages with the end fitting 304b. Further operation of the lever in the same direction causes a leak-tight seal to be formed between the tubing and the end fitting in a manner described below.

FIG. 6C is a cross-sectional view through the center of the piston 303 of the apparatus 300 and also through the center of the tubing 306 that illustrates internal components within the chamber 327 of the piston. FIG. 6C also illustrates that the housing 302 may be affixed to a base plate or external housing 308, so as to provide positional stabilization of the apparatus 300 as previously discussed in regard to other embodiments. The components within the chamber 327 enable the apparatus 300 to provide a leak-tight seal between the tubing 306 and the chromatograph column end fitting 304b, even under high pressures encountered in HPLC applications, without the need for applying any twisting motion or torque to either the tubing or the column.

As may be observed from FIG. 6C, the piston chamber 327 has disposed within it a first helically coiled spring 318a and a second helically coiled spring 318b that has an internal diameter that is greater than the external diameter of the first spring. The springs are disposed such that they are at least partially overlapping—that is, such that at least a portion of the first spring 318a resides within a volume or space defined by the internal diameter of the second spring 318b. The tubing 306 passes substantially parallel to and along the common axis of the two springs 318a, 318b. In operation, the first helically coiled spring 318a (FIG. 6C) transmits a first spring force to the tubing 306 by means of a collar, sleeve or flange 319 that abuts an end of the first spring. The collar, sleeve or flange 319 is either affixed to or tightly engaged with the tubing 306 so as to apply a force to the tubing in a direction substantially parallel to its axis and towards the end fitting 304b. A screw 317 which is threaded into a portion of the piston chamber 327 abuts the other end of the first spring and may be pre-adjusted so as to provide a desired pre-loaded compressional force to the spring. The second helically coiled spring 318b transmits a second spring force to the sealing member 323 by means of an intermediate push plate 320, such as a bushing or a flange. The second spring 318b is restrained within the piston chamber 327 by push plate 320 at the end nearest to the end fitting 304b and by an internal wall 329 of the chamber at the other end. The push plate 320 is restrained within the chamber 327, against the spring forces, by a mechanical stop or stops 328 which are engaged to a piston wall or walls and which may comprise, for example, a set of pins passing through holes in the piston wall, a locking ring or flange secured by an internal groove in an interior piston wall or any other boss or knob engaged to or affixed to the piston. The mechanical stop or stops prevent the springs from pushing themselves and/or other components out of the chamber 327 when the pushing and latching mechanism is in the open position such that the tubing 306 is retracted from the end fitting 304b.

As previously illustrated in and discussed with reference to FIG. 2, the cartridge 40 of the system 30 will generally employ at least four connector apparatuses 48 for fluidic connection to fluid tubing lines. The connector apparatuses may comprise conventional tubing connectors or end fittings. Alternatively, the connector apparatuses may comprise apparatuses, such as those illustrated in FIGS. 4-6 herein, which eliminate the need to use an installation tool or to apply a twisting motion or torque to either the tubing, the columns or the cartridge in general. Since the cartridge 40 is not necessarily limited to containing just two chromatography columns, the will, in general, be a requirement for twice as many connectors as columns in the cartridge. It is thus desirable to be able to connect or disconnect multiple tubing lines to or from the cartridge 40 simultaneously.

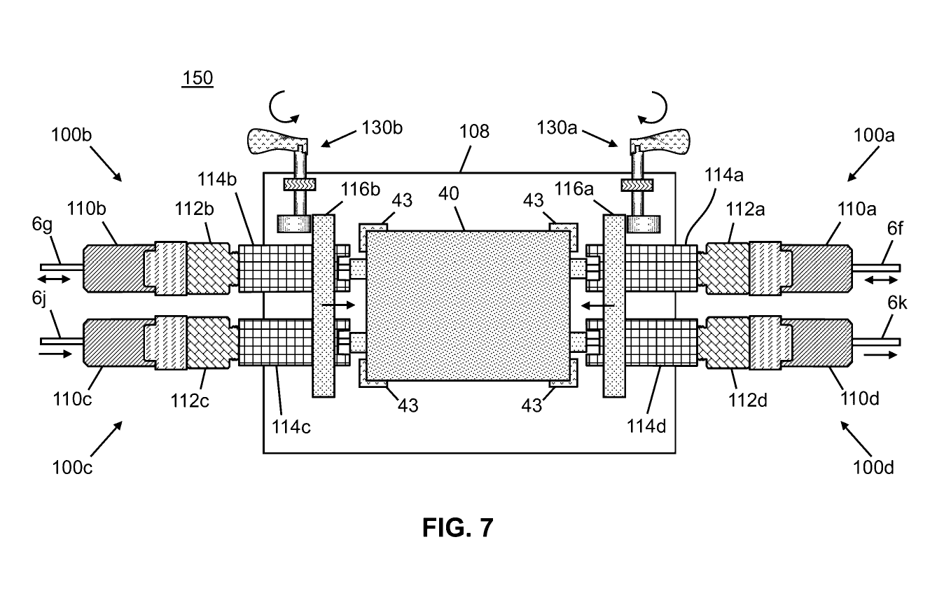

In accordance with the above considerations, FIG. 7 illustrates a system 150 for coupling multiple input tubing and output tubing lines to a cartridge 40 in accordance with the present teachings. The system 150 of FIG. 7 comprises a single base or housing 108 that supports four connector apparatuses 100a-100d (see FIG. 4) by means of a first slidable support member 116a at a first end of the cartridge and a second slidable support member 116b disposed at the opposite end. The slidable support member 116a supports both apparatus 100a and 100d and may be considered, for purposes of this discussion, as the fusion into a single component of the individual separate support members 106 (cf. FIG. 4A) of these two connector apparatuses. Likewise, the slidable support member 116b supports both apparatus 100b and 100c. The cartridge 40 is supported in a fixed position relative to the base or housing 108 by column support members 43.

The connector apparatus 100a, which comprises distal body member 110a, intermediate body member 112a and proximal body member 114a, serves to couple tubing 6f to an end of the first column 42 within the cartridge 40. The connector apparatus 100b, which comprises distal body member 110b, intermediate body member 112b and proximal body member 114b, serves to couple tubing 6g to the other end of the first column. The connector apparatus 100c, which comprises distal body member 110c, intermediate body member 112c and proximal body member 114c, serves to couple input tubing 6j to the input end of the second column 44 within the cartridge 40. The connector apparatus 100d, which comprises distal body member 110d, intermediate body member 112d and proximal body member 114d, serves to couple output tubing 6k to the output end of the second column.

A first clamping mechanism 130a and a second clamping mechanism 130b are each operable by a user so as to provide the compressional clamping motions described previously. In operation of the device 150, the user will place the cartridge 40 into the device and operate both clamping mechanisms 130a, 130b, such as by rotating a lever associated with each clamping mechanism. As previously described, the positioning of the sections of tubing, ferrules or sealing members and column end fittings, as well as the application of the appropriate forces is assured by the device. As the holding force on the tube is separate from the sealing force on the deformable sealing member or ferrule, each can be set only as necessary, enabling reuse of the tube and ferrule many times more as compared to typical combination of tube and ferrule.

The system 150 illustrated in FIG. 7 may employ multiple instances of the connector apparatus 100 (FIG. 4) or instances of the connector apparatuses 140 or 145 (FIG. 5). FIG. 8 illustrates an alternative system 160 which employs multiple instances of the connector apparatus 300 shown in FIG. 6 (or similar apparatuses). Because each coupling apparatus 300 provides a built-in support structure for a column end fitting as well as a slidable piston, the slidable support members (116a, 116b) are rendered un-necessary. All that is required is to attach pairs of the apparatus 300 facing one another on a base plate or external housing 308 (FIG. 8) at an appropriate distance from one another such that the end fittings of the columns of a chromatography cartridge fit easily into the slots recesses or grooves of the two connector apparatuses. For example, FIG. 8 illustrates a cartridge 250 mounted on cartridge support members 43 which are mounted on a base plate or housing 308. For instances of the connector apparatus shown in FIG. 6 are also mounted on the base plate or housing 308. Connector apparatuses 300a and 300b connect inlet and outlet ends of a first column of the cartridge 250 to associated fluid tubing lines and connector apparatuses 300c and 300c provide similar functions with respect to the other column of the cartridge. In this example, electronic or other electrical connections to the cartridge may be facilitated by a connector (not shown) mounted to the base plate or housing 308 beneath the cartridge.

A multiple column cartridge for chromatography systems has been disclosed. Advantageously, a multiple column cartridge in accordance with the present teachings may be employed in an automated sample preparation and analysis system, such as is disclosed in a co-pending International (PCT) application for patent titled “Automated System for Sample Preparation and Analysis” (Attorney Docket No. TFS-13AWO, Application No. PCT/US2011/058452) filed on even date herewith and published as WO 2012/058632 A1. In various embodiments, the automated sample preparation and analysis system includes a sample preparation system for preparing various samples and a sample analysis system, which may include a liquid chromatography mass spectrometer (“LCMS”) for analyzing the prepared samples according to selected analyte assays. The sample preparation system and the sample analysis system are interconnected in an automated manner. A multiple column cartridge in accordance with the present teachings may assist in ease of configuration and use of such an automated system.

The discussion included in this application is intended to serve as a basic description. Although the present invention has been described in accordance with the various embodiments shown and described, one of ordinary skill in the art will readily recognize that there could be variations to the embodiments and those variations would be within the spirit and scope of the present invention. The reader should be aware that the specific discussion may not explicitly describe all embodiments possible; many alternatives are implicit. Accordingly, many modifications may be made by one of ordinary skill in the art without departing from the spirit, scope and essence of the invention. Neither the description nor the terminology is intended to limit the scope of the invention. All patent application publications or other publications are hereby explicitly incorporated by reference herein as if fully set forth herein.

What is claimed is:

1. A method for liquid chromatography comprising:
mixing a sample comprising a plurality of chemical constituents with a first solvent;
transferring the solvent and the plurality of constituents to a first chromatographic column housed in a cartridge;
chromatographically separating a sub-group of the plurality of constituents from unwanted constituents using the first chromatographic column;
transferring the sub-group of the plurality of constituents from the first chromatographic column to a second column housed in the cartridge, the transferring effected by the flow of a second solvent;
chromatographically separating, from one another, individual constituents of the sub-group of the plurality of constituents using the second chromatographic column; and
transferring the separated individual constituents to a detector.
